(19) United States
(12) Patent Application Publication
(10) Pub. No.: US 2021/0362238 A1
(43) Pub. Date: Nov. 25, 2021

(54) MANUFACTURING DEVICE AND METHOD FOR ADDITIVE MANUFACTURING WITH MOVABLE GAS OUTLET

(71) Applicant: EOS GmbH Electro Optical Systems, Krailling (DE)

(72) Inventors: Stefan Zeilinger, Muenchen (DE); Wolfgang Untergehrer, Muenchen (DE)

(73) Assignee: EOS GmbH Electro Optical Systems, Krailling (DE)

(21) Appl. No.: 17/047,199

(22) PCT Filed: Apr. 2, 2019
(86) PCT No.: PCT/EP2019/058261

§ 371 Date: Oct. 13, 2020

(30) Foreign Application Priority Data
Apr. 13, 2018 (DE) 10 2018 108 834.5

(51) Int. Cl. B22F 10/322; B22F 10/28; B22F 12/41; B22F 12/49; B22F 12/70; B33Y 10/00; B33Y 30/00

(52) U.S. Cl. CPC B22F 10/322; B22F 10/28; B22F 12/41; B22F 2201/50; B22F 12/70; B33Y 10/00; B33Y 30/00; B22F 12/49

(57) ABSTRACT

Disclosed is a manufacturing device for the additive manufacturing of a three-dimensional object, wherein the object is manufactured by applying a building material layer by layer and selective solidification of the building material, at points in each layer which are assigned in this layer to the cross-section of the object. The points are scanned with at least one exposure area. The movable gas outlet is assigned during operation to a reference process point and/or a target flow supply zone of the movable gas outlet assigned to the reference process point for the flow supply with the process gas and/or the target ventilation zone of the movable gas outlet.

The invention relates to a manufacturing device and a method for the additive manufacturing of a three-dimensional object using such a manufacturing device, wherein the object is manufactured by applying a building material layer by layer and selective solidification of the building material, in particular by the supply of radiant energy, at points in each layer which are assigned in this layer to the cross-section of the object, whereby the points are scanned or influenced with at least one exposure area, in particular a radiation exposure area of an energy beam bundle.

Additive manufacturing devices and associated methods are generally characterised in that objects are manufactured in them by solidifying a shapeless building material layer by layer. The solidification can be brought about for example by the supply of thermal energy to the building material by means of irradiation of the latter with electromagnetic radiation or particle radiation, for example in laser sintering (“SLS” or “DMLS”) or laser fusion or electron beam fusion. For example, in laser sintering or laser fusion the exposure area of a laser beam (“laser spot”) onto a layer of the building material moves over those points of the layer which correspond in this layer to the cross-section of the object to be manufactured. Instead of introducing energy, selective solidification of the applied building material can also take place by means of 3D-printing, for example by applying an adhesive or a binder. Generally, the invention relates to the manufacturing of an object by means of layer-by-layer application and selective solidification of a building material irrespective of the manner in which the building material is solidified. Use can be made of different types of building materials, in particular powder such as e.g. metal powder, plastic powder, ceramic powder, sand, filled or mixed powder.

In the course of the solidification in additive manufacturing processes, impurities often arise which can penetrate into the process chamber above the building field. DE 10 2014 108 061 A1 relates to a device for the manufacturing of a three-dimensional object by layer-by-layer solidification of building material at the points in the respective layer corresponding to the cross-section of the object to be manufactured by the introduction of energy under a gas atmosphere. It relates moreover to a control unit for such a device and to a method for moving and/or orientating a gas extraction nozzle.

The purpose of the invention is to counteract as efficiently as possible contamination inside the process chamber, in particular in large-field machines.

To solve this problem, the manufacturing device according to the invention for the additive manufacturing of a three-dimensional object is equipped with a building container for receiving the building material, with a process chamber above the building container, with a building field extending horizontally between the building container and the process chamber, with at least one gas inlet for introducing a process gas into the process chamber and with at least one gas outlet for discharging the process gas from the process chamber, wherein the at least one gas outlet, as viewed in plan view onto the building field, can be moved in the process chamber solely outside the building field. Particularly preferable is an outlet opening of the at least one gas outlet, in which it can be moved in at most one degree of freedom in translation and/or in at most one degree of freedom in rotation relative to the building field.

The building container can comprise a building platform, which during operation carries the component to be manufactured and surrounding unsolidified building material. An opening plane of the building container defines a building field, which represents a working plane in which the building material is applied in a metered manner as an individual layer. The building field thus usually extends essentially over the base area of the building container. Moreover, the process chamber is located above as a hollow space above the building field or the working plane in which at least one coating device operates. The process chamber is, amongst other things, defined by (in particular vertically) ascending walls, the arrangement of which often follows the outline shape of the building field and which observes a certain distance from the building field in order to keep a working space free for example for the coating equipment. The walls of the process chamber are often arranged in a rectangular ground plan, but their ground plan can also assume other shapes diverging therefrom, such as for example a circular shape. In addition, the walls do not have to be constituted with a continuously flat surface, but can have horizontal or vertical protrusions or recesses, niches, rounded corners at their transitions, bulges or indents or be constituted otherwise fissured. For the sake of simplicity, a regular cuboid process chamber with flat vertical walls will be adopted in the following, insofar as no other features are stated. Designs of the walls diverging therefrom are therefore not excluded, but are intended—insofar as advisable and possible—to be included by the description.

The manufacturing device can in particular comprise a guiding device, e.g. a laser scanner unit, for guiding at least one energy beam bundle of the radiant energy through at least one section of the process chamber onto the building field. As a basis for the guidance, the points in each layer, which are assigned in this layer to the cross-section of the object, serve as geometrical locations of the planned exposure to the radiant energy. The guiding device can couple one or more energy beam bundles directed onto the building field for example through a transparent coupling window at the upper side of the process chamber. The location or locations at which the energy beam bundle or bundles strike the building field and therefore the building material, and proceeding from which solidification of the building material (“actually”) takes place, is/are denoted as a radiation exposure area. As already described further above, the selective solidification of the building material can take place with different methods. The conceptual difference between exposure area and radiation exposure area is based in the following on whether a selective solidification takes place without radiation—then one speaks of “exposure area”—or with the use of radiation—than one speaks of “radiation exposure area”. The invention is not limited to radiant energy as a means for the selective solidification. During the scanning of the building material with a radiation exposure area, the radiation onto the building material acts in the radiation exposure area in such a way that a solidification of at least one uppermost layer of the building material is brought about. As a result of the energy supply in the radiation exposure area, the building material is partially or completely melted, as a result of which the components of the building material, for example powder grains, bind together. After its cooling, the former building material is then present as a solid body.

In order to make it clear that the area of the radiation exposure area on the building material does not necessarily have to be very small (“point-like”), the term “energy beam bundle” is often also used in this application. It is also used within the scope of the application, however, as distinct from further radiation sources which may be used to heat the building material, e.g. IR radiant heating. The term “energy beam bundle” is defined such that a sufficient radiation intensity is provided over its radiation exposure area on the building field in order to solidify the underlying building material with a depth extent of at least one layer. The invention is however not restricted to energy beam bundles as radiation energy.

An additive manufacturing device can comprise a number of radiation sources for generating radiation and a number of guiding devices connected to the latter for directing the radiation onto the building material. In particular, precisely one radiation exposure area on the building material is preferably assigned to a guiding device. The radiation sources can for example be one or more gas or solid-state lasers or another kind of lasers such as for example laser diodes, in particular VCSELn (Vertical Cavity Surface Emitting Laser) or VECSELn (Vertical External Cavity Surface Emitting Laser) or a row of these lasers.

The process gas to be introduced into the process chamber through the gas inlet and discharged through the gas outlet can be a gas mixture or a pure gas. In specific additive manufacturing processes, use is often made of process gas with a high proportion of inert gas, e.g. argon or nitrogen. In some cases, use of cost-effective gas mixtures may suffice, the composition of which corresponds for example to ambient air.

According to the invention, the manufacturing device comprises at least one gas inlet for the flow supply with process gas, which is arranged in the process chamber. The gas inlet can comprise a device, e.g. a nozzle or a housing, optionally with a connected gas supply line from the process gas supply. Within the scope of the application, however, the gas inlet is understood in particular as an opening from which the gas flows into the process chamber. The gas inlet opening thus forms an interface between a hollow space of the gas supply device and a hollow space formed by the process chamber. When it leaves the gas inlet, a process gas flow is transformed from a guided jet into an unguided jet or a free jet. The gas inlet or the gas inlets can be arranged movably or stationary, i.e. stationary relative to the process chamber, inside the process chamber essentially over the entire building field. Mention is usually made in the following of only a single gas inlet, even though a plurality of gas inlets—insofar as advisable—are possible according to the invention and are in principle intended to be included by the description.

The gas outlet or the gas outlets in total, but at least its or their outlet opening(s) are preferably movable in at most one degree of freedom in translation and/or at most one degree of freedom in rotation relative to the building field. As a rule, either the translatory or the rotational mobility of the at least one gas outlet suffices. Said mobility is ensured structurally, i.e. at least by means of mechanical or motorised movable devices, and using control technology in the sense of a control of the movable devices. Quite generally, the gas outlet or the gas outlets is/are movable inside the process chamber, viewed in a vertical plan view onto the building field, solely outside the building field. The at least one gas outlet as a three-dimensional body is thus moved in a partial space of the process chamber above the extension plane of the two-dimensional building field and there only in a frame-like area of the process chamber which does not lie above the building field. Mention is usually made in the following of only one single gas outlet, even though a plurality of gas outlets—insofar as advisable—is possible according to the invention and in principle intended to be included by the description.

The gas outlet can comprise devices of many designs, e.g. a nozzle, a possibly multi-segment pipe section or a housing for example flexible in sections, optionally with a connected gas extraction system, optionally to a process gas cleaner. In particular, the two-dimensional outlet opening of the gas outlet, through which gas flows away out of the process chamber, is functionally relevant. The structural design of the gas outlet is used for its mobility. It is therefore movable at least in sections, so that at all events the position of its outlet opening can be changed in space or relative to the building field. The outlet opening usually extends in a plane orthogonal to the extension plane of the building field and can, in contrast with the latter, be moved in translation and/or rotation and in a horizontal movement plane parallel to the latter. The rotational movement may mean a rotation of the outlet opening or also the swivelling thereof. The outlet opening forms a usually vertical interface between a hollow space of the gas discharge device downstream of the outlet opening and a hollow space formed by the process chamber.

The invention thus avoids providing either an immovable “global” gas outlet, which often occupies of the order of a building field width, or providing a movable gas outlet which is positively guided, optionally together with the gas inlet, over the building field. Whereas the global gas outlet operates locally in an untargeted manner, the movable gas outlet itself usually requires a high coordination and control outlay, which also increases due to the required coordination with the guiding devices. In contrast, the invention makes it possible to combine the more targeted effect of a movable gas outlet with a building field kept free, as a result of which a collision of devices for the gas outlet with an energy beam bundle is eliminated and specific areas above the building field can be freed more effectively from contaminated process gas (also referred to in the following as “ventilation”), which at a specific point in time require cleaning and/or possibly increased cleaning capacity.

The invention pursues the aim of reducing and/or removing atmospheric impurities by means of removal of the process gas loaded with impurities and in an as effective and targeted manner as possible. The mobility of the gas outlet (or its outlet opening) makes it possible to displace its target ventilation zone and thus also to coordinate its effect better with a possibly displaceable target flow supply zone of the gas inlet.

A target ventilation zone of a process gas discharged from the process chamber by means of the gas outlet is typically a partial area of the process chamber preferably close to the building field. Viewed in a vertical projection onto the building field, it can lie inside the building field outline and/or outside the building field outline, i.e. above a process chamber floor surrounding the building field. The target ventilation zone preferably comprises an area in which one or more beam paths of one or more energy beam bundles runs/run at least in sections at the present time. A location, an extension and/or an orientation of the target ventilation zone can in principle be constant or variable. It or its dynamic change can in each case be at least indirectly dependent on location/extension/orientation of the radiation exposure area or its dynamic change. The position of the target ventilation zone can be coordinated with a position of the gas outlet or move with it. The target ventilation zone, viewed in the vertical plan view onto the building field and relative to the process gas flow, typically lies at least downstream of the radiation exposure area or areas (related to the flow direction of an inflowing gas volume). The target ventilation zone can be understood as a minimum coverage area of a gas-discharge or gas-suction effect of a (defined) movable gas outlet, wherein a minimum degree of effectiveness or cleaning effect is preferably assumed in the minimum coverage area. In this case, therefore, an actual zone of the ventilation may be larger by means of the gas outlet. The shorter the distance of the gas outlet or the gas is to the target ventilation zone, the more concentrated its effect can be there. Optionally, i.e. not necessarily, the target ventilation zone covers a radiation exposure area and optionally a surrounding area of the radiation exposure area on the building field surface.

A target ventilation zone of a process gas flowing into the process chamber by means of the gas inlet is typically a partial area of the process chamber preferably close to the building field. Viewed in a vertical projection onto the building field, it can lie inside the building field outline and/or outside the building field outline, i.e. above a process chamber floor surrounding the building field. The target flow supply zone preferably covers an area in which one or more beam paths of one or more energy beam bundles runs/run at least in sections at the present time. A location, an extension and/or an orientation of the target flow supply zone can in principle be constant or variable. Its or their dynamic change can in each case be at least indirectly dependent on location/extension/orientation of the radiation exposure area or its dynamic change. A position of the target flow supply zone can be coordinated with a position of the gas inlet or move with it. The target flow supply zone, viewed in the vertical plan view onto the building field and relative to the process gas flow, typically lies at least downstream of the radiation exposure area or areas. The target flow supply zone can be understood as a minimum coverage area of a local flow supply or injection of a process gas through a gas inlet, wherein a minimum degree of effectiveness or cleaning effect is preferably assumed in the minimum coverage area. In this case, therefore, an actual zone of the flow supply may be larger by means of the gas outlet. The shorter the distance of the gas outlet is to the target flow supply zone, the more concentrated its effect can be there in. Optionally, i.e. not necessarily, the target flow supply zone covers a radiation exposure area and optionally a surrounding area of the radiation exposure area on the building field surface.

Location, extension and/or orientation of the target ventilation zone and of the target flow supply zone are preferably matched to one another. This can take place by coordinating the position, orientation and/or movement of one or more gas outlets and gas inlets.

The aim of keeping cleaning or cleaning of the target ventilation zone is thus achieved by the solution according to the invention. A dispersion or spread of the impurity downstream of the radiation exposure area due to the free jet escaping from the gas inlet can for example be countered, in that the outlet opening of the gas outlet has a larger extent than the gas inlet opening especially of a gas inlet, so that the impurity despite a certain spread can be pushed directly into the gas outlet. A thinning-out of the impurity accompanying its spread, moreover, brings about a reduced degree of disruption, if an energy beam bundle passes through it before its removal from the process chamber.

In addition, with increasing distance of their unlimited course, free jets lose both a clear direction and also speed on account of their fanning-out. The device according to the invention, especially when a movable gas inlet is used, can shorten a distance between gas inlet and gas outlet and therefore uphold a target accuracy and efficiency of an unguided process gas flow with regard to its displacing and therefore cleaning function. It thus gains all the more value, the larger a building field is and the greater the distance between a stationary gas inlet arranged along the building field and a stationary gas outlet. This makes its use profitable especially in the case of large-field plants, without requiring a comparably high coordination and control outlay, which a combination of gas inlets and outlets simultaneously movable (or coordinated) above the building field signifies. In contrast with a small-field plant, a large-field plant can for example have a building field, whereof the shortest side length of a rectangular building field or the diameter thereof in the case of a circular building field amounts to at least 400 mm, preferably at least 800 mm, particularly preferably at least 1000 mm.

In the case of the selective solidification of metal, in comparison with other additive manufacturing processes, an increased amount of contamination of the process chamber atmosphere may possibly occur. The contamination can include for example splashes, smoke, condensate or other suspended particles. It can absorb or scatter at least a part of the radiant energy directed in the form of the energy beam bundle towards the building field before said radiant energy reaches the building field, as a result of which a solidification process can be impaired. Use of the invention in connection with additive manufacturing processes and devices is thus particularly advantageous, in which a metallic or at least metal-containing building material is used, which contains at least 50% by volume, preferably at least 80% by volume, particularly preferably at least 90% by volume of metal. The metallic building material can for example be a homogeneous metal powder or a metal alloy powder.

According to an embodiment of the invention, the outlet opening can be arranged in a wall of the process chamber and/or adjacent to or close to an edge of the building field. In the wall of the process chamber, it can be constituted for example as a mere location-variable opening or a more expensive case as a movable nozzle in a recess of the wall of the process chamber. The building field edge on the one hand and the wall of the process chamber on the other hand define the space in which the outlet opening can move or the movable devices of the gas outlet required for this can extend. The mobility of the devices of the gas outlet need not only serve for the mobility of the outlet opening, but may also have the purpose of making precisely the space between the building field edge and the wall of the process chamber wholly or at least partially free if need be, i.e. if for example the coating device temporally requires a movement clearance.

In principle, the outlet opening can be arranged adjacent to or close to an edge of the building field. Moreover, the outlet opening can in principle be designed movable in the direction towards the building field or away from the building field, for example to prevent a collision with other movable components in the process chamber (for example coaters or suchlike). A mobility of the outlet opening with a vertical component is also possible.

According to a further embodiment of the invention, the outlet opening can be arranged so as to be displaceable essentially horizontally. “Essentially horizontally” is understood here to mean that the horizontal movement component is the main movement component, in particular the displaceability of the outlet opening from the horizontal deviates at most by 25°, preferably at most by 10°, particularly preferably at most 5°, wherein it is desirable in principle to enable or produce a precisely horizontal displaceability. If the outlet opening can be moved along a building field edge, the building field can be completely covered from one of its edges, insofar as the effective range extends from the outlet opening at least as far as the building field beneath extends. In a suitable embodiment, the outlet opening can be constituted on a movable nozzle, which can be moved parallel to a building field edge (i.e. in a plane perpendicular to the building field). According to an alternative suitable embodiment, the outlet opening can be constituted on a movable nozzle such that it can move along a curved path, e.g. in a circle-segment shaped arc, relative to the building field edge in a plane parallel to the building field. The nozzle can be guided as a kind of runner for example on a rail, which is connected downstream via a hose or via a flexible tube to the gas-conveying line inside the manufacturing device. The course of the rail guide can be orientated according to the outline shape of the building field, in the case of a rectangular building field running close by linearly and parallel to a building field edge, in the case of a circular building field, on the other hand, running for example in an arc shape. For structural reasons for example, courses of the rail guide independent of the edge of the building field may also be advisable, for example convex or concave courses beside a building field delimited by a rectangular shape or linear courses in the case of a building field delimited by a curved shape.

Alternatively, the outlet opening can be arranged in the area of the wall of the process chamber. According to a further embodiment of the invention, the outlet opening can be implemented in the manner of a slider for an opening in the wall of the process chamber, i.e. by a door or wall section displaceable in the plane of the wall of the process chamber, which only partially covers a fluidically connected aperture or an opening in the wall at least when there is an active gas outlet and also displaces the remaining partial opening as an outlet opening by its displacement relative to the wall. The displacement of the slider is not limited to a translatory movement, but can also be displaced in rotation in front of the aperture, but essentially in its opening plane, as a result of which the outlet opening can be displaced. The gas outlet formed in this way can also comprise a plurality of displaceable sliders, which activate in each case one outlet opening alone or a plurality of outlet openings in common. The gas outlet can comprise for this purpose an outlet funnel divided parallel to its main flow direction, which offers a number of outlet cells, i.e. its total volume is split up into defined partial volumes. The outlet cells or partial volumes each comprise opening areas into the process chamber. Selective closure of the opening areas of the outlet cells or partial volumes displaces the opening areas and thus leads to at least one movable outlet opening in the area of the process chamber wall.

An outlet opening can consequently also be composed of a plurality of opening areas. According to a further embodiment of the invention, the outlet opening can have a variable opening cross-section. It can thus be constituted variable not only with regard to its horizontal position in respect of the building field, but can also offer a variable size. In the case of a constant gas flow through the outlet opening, an effective range of the gas outlet into the depth of the process chamber can also thus be influenced—at least when there is a removal—with the change in its opening cross-section. The change in the opening cross-section can take place for example by a corresponding control of the upper slider in front of the individual opening areas. It is important in this connection that a complete shut-off of the outlet opening in the sense of the total closure of the opening cross-section is no longer understood as a “movement of the outlet opening”, but as a complete blocking of the outlet opening.

According to a further embodiment of the invention, at least two outlet openings movable independently of one another can be arranged one above the other on the same side of a building field. For example, two rails can run one above the other beside the building field, on which a gas outlet nozzle can be moved back and forth in each case independently of one another. Alternatively, two outlet openings of one or two separated gas outlets can be arranged one above the other in one of the ways described above in the wall of the process chamber. The outlet openings can thus be arranged one above the other in order to increase an effective range or at least to generate two separate effective ranges.

According to a further embodiment of the invention, at least two outlet openings movable independently of one another can be arranged beside the building field and at an angle to one another. They can be fitted or housed at sides of the building field adjacent to one another and/or lying opposite to one another and there at its edge or on or in the wall of the process chamber. An effective direction of the gas discharge from the building field can thus be varied, for example depending on a flow supply direction through the gas inlet. The arrangement of a plurality of gas outlets in different directions can also enable their simultaneous operation, so that their effective directions will intersect on the building field. At least theoretically, even an at least local 360° exposure onto the building field is possible if the building field has gas outlets or outlet openings on all its sides.

According to a further embodiment of the invention, the travel path or the opening of the gas outlet can have at least the length of a building field side, along which it acts. With regard to the “opening of the gas outlet”, it is assumed that it can be closed in sections and during operation is correspondingly locally closed and the movable or displaceable outlet opening forms the respective non-closed area of the opening. The “travel path”, on the other hand, relates at least to the outlet opening of the gas outlet independently of its structural design. With a suitable distance between the gas outlet and the building field or a suitable process gas volume flow, the gas outlet ensures its reliable exposure at least onto the entire building field edge running along the building field side, without for example suffering losses of effect at its ends. A comparatively large horizontal, but also vertical extension of the outlet opening of the gas outlet works against an efficient coverage especially of a process gas jetted in as a free jet and thereby widening or of the process gas flow spreading out or of the process gas volume blown away.

According to a further embodiment of the invention, a horizontal extension of the at least one outlet opening is smaller than a horizontal extension of the adjacent side of the building field. The horizontal extension of the outlet opening preferably amounts to at most 50%, more preferably at most 30%, particularly preferably at most 20% of the horizontal extension of the adjacent building field side.

In a simple case, at least one outlet opening per reference process point and/or per defined target ventilation zone or target flow supply zone can be provided. According to a further embodiment of the invention, more than one gas outlet can be assigned to a reference process point and/or a target ventilation zone and/or a target flow supply zone. Two or more gas outlets or outlet openings can thus serve a single reference process point and/or target ventilation zone and/or target flow supply zone in the building field, in order to free the reference process point and/or the target ventilation zone and/or the target flow supply zone more effectively from any process gas loaded with impurities and thus to effectively counteract impurities there.

A “reference process point” can comprise one or more (radiation) exposure area(s) present at a point in time (in particular of the energy beam bundle or bundles) on the building field. Optionally, it can also comprise a defined movement area of the (radiation) exposure area(s), the extension whereof can be defined for example by a predetermined time span, in which the current (radiation) exposure area(s) is/are moved on the building field. It is preferably understood as a two-dimensional section from the working plane or the building field surface. The reference process point can, for example depending on a given applied irradiation strategy, for example be a section of a stripe or a path (“stripe” irradiation strategy), which is typically defined by the constant maximum width. Alternatively, it can comprise for example—in parts or completely—the area of a “chess field” in a so-called “chess” irradiation strategy. The stripes and chess fields mentioned by way of example are usually “hatched out” in terms of high frequency by the energy beam bundle. A location, an extension and/or an orientation of the target ventilation zone or the target flow supply zone or their dynamic change can be dependent at least indirectly on the location, the extension and/or the orientation of the reference process point or its dynamic change.

According to a further embodiment of the invention, the outlet opening can be movable in a lower half, preferably in a lowest fifth, particularly preferably in a lowest tenth of the process chamber related to the clear height of the process chamber, in each case viewed perpendicular to the building field. Since a process chamber can comprise a fissured interior space, e.g. a non-uniform height level of the roof, the term “clear height” relates to a maximum internal height of the process chamber. For example, the stated values with regard to the clear height of the process chamber can correspond to a distance value in an operation of the gas outlet as intended of less than or equal to 20 cm, preferably less than or equal to 10 cm, particularly preferably less than or equal to 5 cm from the building field. In the stated height ranges of the process chamber, a particularly high effectiveness of the gas outlet is to be expected. Moreover, it is thus distinguished from a possible separate outlet of a roof flow supply, which usually acts for example in an upper half or in an upper quarter of the process chamber and in particular serves for purging or shielding of a coupling window for the supply of radiant energy. The gas inlet can also be arranged at a height level corresponding to the gas outlet.

At least experimentally, it can be established that there is a detectable difference in effect between injection through a gas inlet and discharge or extraction through a gas outlet. Accordingly, the effectiveness of injection is several times greater than that of extraction. According to a further embodiment of the invention, therefore, the movable outlet opening can cooperate with a movable gas inlet in order to achieve a still higher degree of effectiveness. The movable gas inlet can be advanced close to a radiation exposure area or to a target flow supply zone and can act locally there. In combination with a discharge or extraction of the process gas from the target ventilation zone and/or at least from an area of the process chamber above the reference process point through the gas outlet, the efficiency of the manufacturing device according to the invention can be ensured.

In contrast with a global injection, wherein a complete building field or a volume inside the process chamber above the building field is exposed to a flow, wherein the base area of the volume at least corresponds to the extent of the building field, the movable gas inlet acts locally, in that it approaches only a partial area of the building field, i.e. a partial volume above the building field, wherein the base area of the volume corresponds to a partial area of the building field. The embodiment with a movable gas inlet pursues the aim of reducing and/or removing atmospheric impurities by means of an inflow and therefore displacement and/or dilution of the impurity with an impurity-free process gas or a process gas that is at least low in impurities, which is removed in a targeted manner beyond a point of impact of the energy beam bundle on the building field. Moreover, on account of further features of the movable gas inlet, reference is made to the parallel application with the title “manufacturing device and method for additive manufacturing with movable flow supply” and with application number EM2017-073 of the same date, which in this regard also becomes the content of the present application.

The movable gas outlet, optionally synchronised with a likewise movable gas inlet, does not exclude the fact that the manufacturing device according to a further embodiment has a “global inflow”. This can be a roof flow supply or roof injection, which usually acts for example in an upper half or in an upper quarter of the process chamber and in particular serves for purging or shielding of a coupling window for the supply of radiant energy. Alternatively or in addition to the roof flow supply, a downwardly directed flow introduced over a comparatively large area can be provided, which, similar to a clean room flow, reduces an ascent of impurities into an upper area of the process chamber or keeps impurities close to their place of origin in the lower area of the process chamber, while they are diluted or removed. Alternatively or in addition, it may be a lateral inflow with a higher speed. The movable gas outlet can be provided for also collecting the gas volume which has additionally flowed in.

The problem mentioned at the outset is also solved by a method for the manufacturing of a three-dimensional object by means of an additive manufacturing device of the type described above with at least one gas inlet and at least one movable gas outlet for process gas, wherein the object is manufactured by the application of a building material layer upon layer and selective solidification of the building material, in particular by means of supplying radiant energy, at points in each layer which are assigned in this layer to the cross-section of the object, in that the points are scanned with at least one exposure area, in particular a radiation exposure area of an energy beam bundle, wherein the movable gas outlet is assigned during operation to a reference process point and/or a target ventilation zone of the movable gas outlet assigned to the reference process point.

In the case of a movable embodiment of the gas inlet, according to a preferred development of the method, the movable gas outlet is assigned during operation to a target flow supply zone of the gas inlet assigned to the reference process point.

With the assignment of the movable gas outlet to a reference process point and/or to a target ventilation zone, the invention pursues the principle of removing any contaminated gas volume from the target ventilation zone. The focusing of the effect of the gas outlet by means of a movable outlet opening increases the efficiency of the gas removal. For example, the aim of an impurity-free supply of radiant energy onto the building field can thus be achieved, but without the use or throughput of large gas volumes. In principle, the movable gas outlet can be assigned to a radiation exposure area of an energy beam bundle typically moved rapidly over the building field during operation of the manufacturing device. The assignment to a reference process point and/or to a target ventilation zone defines a requirement threshold for the control of the gas outlet, which can lead to a reduction of the movements of the gas outlet. A gas flow guided through the process chamber or over the building field can be smoothed, since its passage time is usually considerably longer than the dwell time of a radiation exposure area at a process point on the building field. This can increase the effectiveness of the removal of impurities from the process chamber.

According to a first embodiment of the method, the adjustment of the position of the gas outlet and therefore the control of the movement of the outlet opening can take place dependent on a local impurity concentration in the process chamber detected above the building field. The detection of a local impurity concentration, for example a smoke concentration, can also take account of other influences beyond the position and orientation of the gas inlet, for example influences of a further flow of another gas inlet or a roof flow supply. The movement of the outlet opening with regard to its desired effect can thus be controlled more precisely. Its control can optionally comprise a connection to a monitoring system, which for example continuously detects a local concentration of impurities of the process chamber atmosphere at least in a partial area of the process chamber.

According to a further embodiment of the method, the orientation of an opening of a movable gas inlet can be adjusted dependent on a position or orientation of the outlet opening of the gas outlet. In the case of a movable gas opening, its position in the case of a swivellable outlet opening represents its orientation, the reference point for the control of the gas inlet. The gas inlet opening is preferably positioned and orientated such that it always lies opposite the gas outlet opening, in a vertical plan view onto the building field, during operation of the flow supply device This control promises a high efficiency of the interaction of the gas inlet and gas outlet, which can be reflected, amongst other things, in a low use or throughput of process gas.

A direct coaxial alignment of the gas inlet and the gas outlet possibly cannot always be implemented during a manufacturing process due to process-related reasons. According to a further embodiment of the method, the control of the gas inlet and the gas outlet can therefore take account of a predefined angle threshold value, so that an angle, which encloses the opening planes of the inlet opening of the gas inlet and outlet opening of the gas outlet with one another, viewed in a vertical plan view onto the building field, does not exceed the angle threshold value. The angle threshold value consequently enables a certain tolerance with respect to a desired optimum alignment of the gas inlet and the gas outlet with one another, but which includes a functionally possible deviation of the alignment without serious losses of efficiency. The control outlay for the gas inlet and the gas outlet can thus be reduced.

The problem mentioned at the outset is also solved by a control method for a method for producing a three-dimensional object by means of an additive manufacturing device with a gas inlet and a movable gas outlet for process gas, wherein the object is manufactured by the application of a building material layer upon layer and selective solidification of the building material, in particular by means of supplying radiant energy, at points in each layer which are assigned in this layer to the cross-section of the object, in that the points are scanned with at least one exposure area, in particular a radiation exposure area of an energy beam bundle, wherein the control method is constituted such that it assigns to the movable gas outlet during operation a reference process point and/or a target ventilation zone of the movable gas outlet assigned to the reference process point.

The generation of control command data in the context of the control method can be implemented for example in the form of hardware and/or software components in a computing device. The computing device can for example be part of the above manufacturing device for the additive manufacturing of a three-dimensional object itself, for example as part of a control system or suchlike. Alternatively, the generation of the control command data can proceed independently and separately, i.e. be carried out spatially separated from the manufacturing device. The generated control command data can then be fed to the manufacturing device by means of suitable interfaces, for example via a memory stick, a movable hard disc or another transportable data carrier as well as via cable-based or cableless networks or “Cloud” solutions.

The problem mentioned at the outset is also solved by a computer program product with a computer program, which can be loaded directly into a memory device of a control data generation device and/or of a control device of the aforementioned manufacturing device for the additive manufacturing of a three-dimensional object, with program sections in order to carry out all the steps of a method according to the invention, when the computer program is executed in the control data generation device and/or in the control device. An implementation in the invention carried out largely by software has the advantage that previously used control devices can also be retrofitted in a straightforward manner by a software or hardware update in order to operate in the manner according to the invention. Such a computer program product can comprise, apart from the computer program, optionally additional components such as for example documentation and/or additional components, also hardware components, such as for example in a hardware key (Dongles etc.) for using the software. For the transport to the control device and/or for the storage on or in the control device, a computer-readable medium, for example a memory stick, a movable hard disc or another transportable or fixedly installed data carrier can be used, on which the program sections of the computer program readable and executable by a computing device for generating control command data and/or the control device are stored.

The principle of the invention is explained in greater detail below by way of example with the aid of a drawing. In the figures:

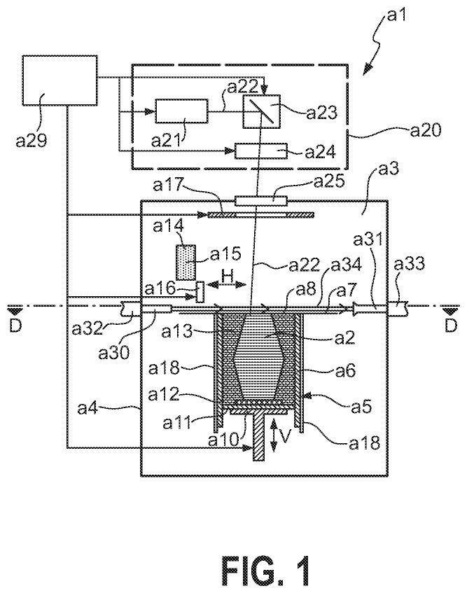

FIG. 1: shows a diagrammatic view, represented partially in cross-section, of a device for the additive manufacturing of manufacturing products according to the prior art,

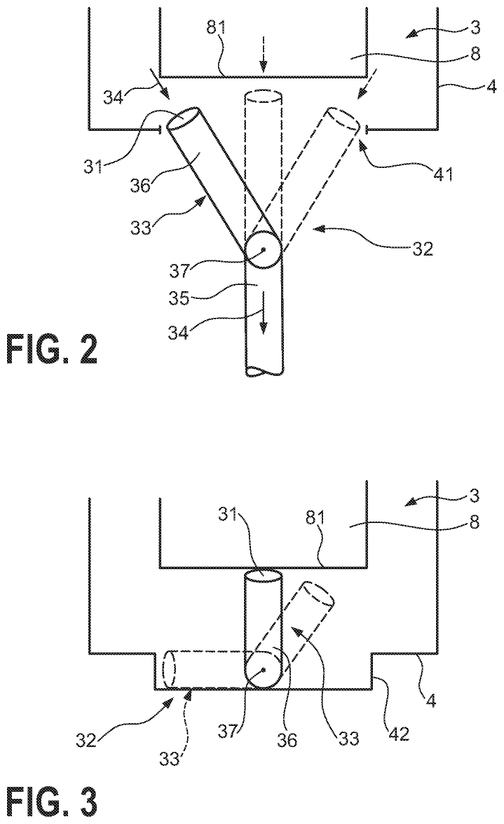

FIG. 2: shows a diagrammatic partial cross-sectional view of a device according to an embodiment of the invention with a swivellable gas outlet in the plane corresponding to intersecting line D-D according to FIG. 1,

FIG. 3: shows a diagrammatic cross-sectional view of the device according to an alternative embodiment of the invention with a swivellable gas outlet,

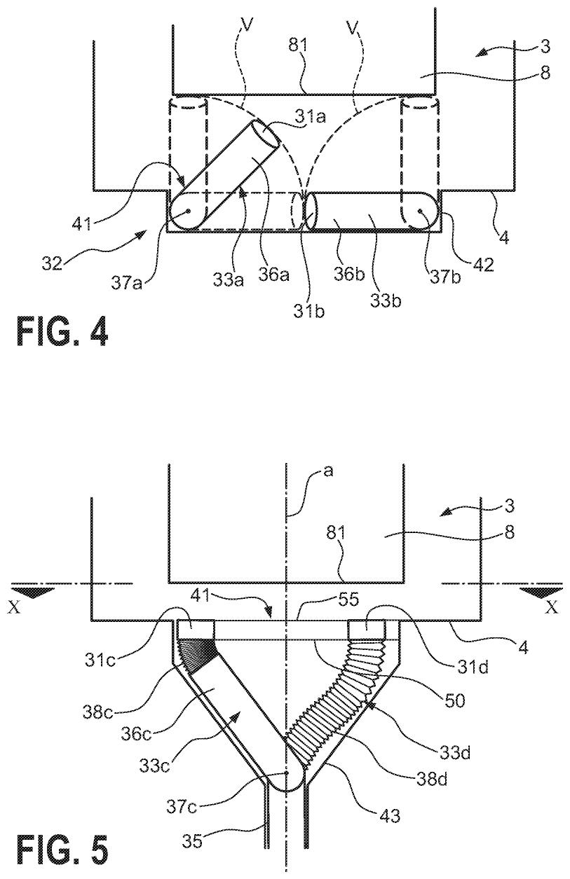

FIG. 4: shows a diagrammatic cross-sectional view with two swivellable gas outlets according to a further embodiment of the invention,

FIG. 5: shows a diagrammatic cross-sectional view with two embodiments of a movable gas outlet according to a further embodiment of the invention,

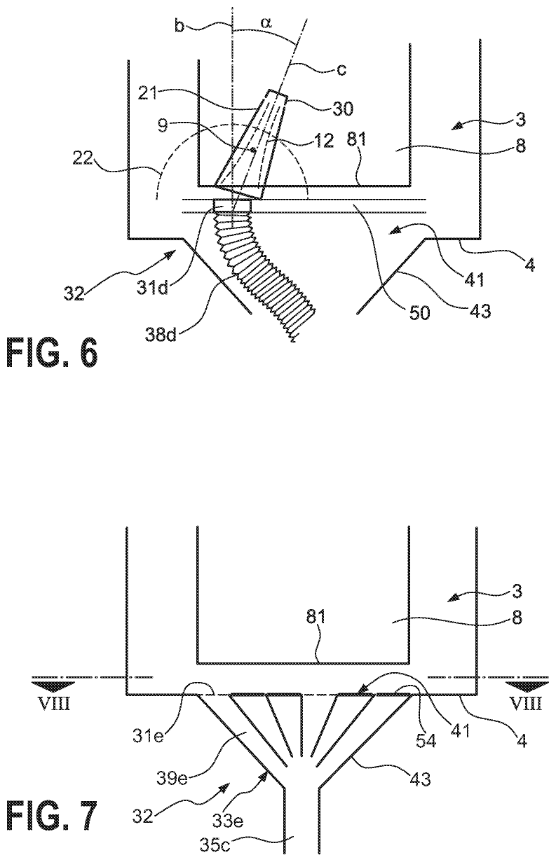

FIG. 6: shows a diagrammatic cross-sectional view with an alternative movable gas outlet according to a further embodiment of the invention,

FIG. 7: shows a diagrammatic cross-sectional view with an alternative movable gas outlet according to a further embodiment of the invention,

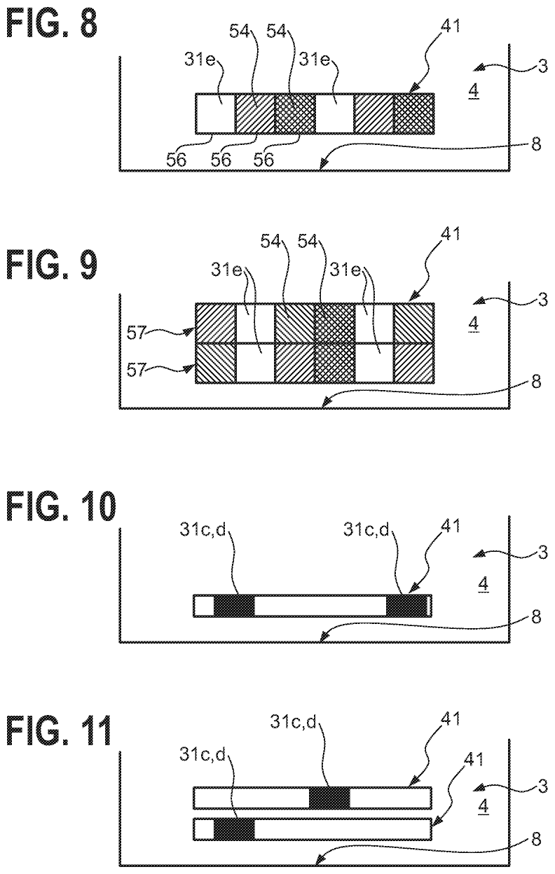

FIG. 8: shows a view of the process chamber wall according to intersecting line VIII-VIII in FIG. 7,

FIG. 9: shows a further such view with two gas outlets one above the other,

FIG. 10: shows an alternative view to FIG. 8, and

FIG. 11: shows an alternative view to FIG. 9 with two gas outlets one above the other.

The device represented diagrammatically in FIG. 1 is a laser sintering or laser fusion device a1 known per se. For the build-up of an object a2, it contains a cuboid process chamber a3 with a plane-surfaced chamber wall a4. An upwardly open building container a5 with a wall a6 is arranged in process chamber a3. A working plane a7 is defined by the upper opening of building container a5, wherein the area of working plane a7 lying inside the opening, which can be used for building up object a2, is referred to as building field a8.

Arranged in container a5 is a carrier a10 movable in a vertical direction V, to which a base plate all is fitted, which terminates building container a5 downwards and thus forms the bottom thereof. Base plate all can be a plate formed separated from carrier a10, which plate is attached to carrier a10, or it can be formed integrally with carrier a10. Depending on the powder used and the process, a building platform a12 can also be fitted on base plate all, on which platform object a2 is built up. Object a2 can however also be built up on base all itself, which then serves as a building platform. In FIG. 1, object a2 to be formed in building container a5 on building platform a12 is represented below working plane a7 in an intermediate state with a plurality of solidified layers, surrounded by building material a13 which has remained unsolidified.

Laser sintering device a1 also contains a storage container a14 for a powder-like building material a15 which can be solidified by electromagnetic radiation and a coater a16 movable in a horizontal direction H for applying building material a15 onto building field a8.

Laser sintering device a1 also contains an illumination device a20 with a laser a21, which generates a laser beam a22, which is deflected by deflection device a23 and focused onto working plane a7 by a focusing device a24 via a coupling window a25, which is fitted at the upper side of process chamber a3 in its wall a4.

Laser sintering device a1 also contains a control unit a29, via which the individual components of device a1 are controlled in a coordinated manner to perform the building process. Control unit a29 can contain CPU, the operation of which is controlled by a computer program (software). The computer program can be stored separated from the device on a storage medium, from which it can be loaded into the device, in particular into control unit a29.

During operation, carrier a10 is first lowered, for the application of a powder layer, by a height which corresponds to the desired layer thickness. A layer of powder-like building material a15 is then applied by moving coater a16 over working plane a7. For safety, coater a16 pushes a somewhat larger quantity of building material a15 in front of it than is required for the build-up of the layer. The intentional excess of building material a15 is pushed by coater a16 into an overflow container a18. An overflow container a18 is arranged in each case on both sides of building container a5. The application of powder-like building material a15 takes place at least over the entire cross-section of object a2 to be manufactured, preferably over entire building field a8, i.e. the area of working plane a7, which can be lowered by a vertical movement of carrier a10.

The cross-section of object a2 to be manufactured is then scanned by laser beam a22 with a radiation exposure area, so that powder-like building material a15 is solidified at process points which correspond to the cross-section of object a2 to be manufactured. These steps are repeated until such time as object a2 is completed and can be removed from building container a5.

To generate a preferably laminar gas flow a34 in process chamber a3, laser sintering device a1 also contains a gas supply channel a32, a gas inlet nozzle a30, a gas extraction nozzle a31 and a gas discharge channel a33. Gas flow a34 moves away over building field a8. The gas supply and discharge can also be controlled by control unit a29. The gas extracted from process chamber a3 can be led to a filtering device (not shown), and the filtered gas can be fed via gas supply channel a32 back to process chamber a3, as a resuit of which an air circulation system with a closed gas circuit is formed. Instead of just one gas inlet nozzle a30 and one gas extraction nozzle a31, a plurality of nozzles can also be provided in each case. FIG. 2 shows a diagrammatic partial cross-sectional view onto a device according to the invention with a swivellable gas outlet 32 in a plane corresponding to intersecting line D-D according to FIG. 1. FIG. 2 shows a plan view of cuboid process chamber 3, which is surrounded by plane-surfaced, vertically projecting chamber wall 4. Rectangular building field 8 lies inside process chamber 3.

Chamber wall 4 has a rectangular opening 41 extending essentially horizontally, which lies on a side of building field 8 facing a building field edge 81. It lies at a height just above building field 8 and has a width which corresponds approximately to the length of building field edge 81. A gas discharge channel 33 of gas outlet 32 projects through opening 41, said gas discharge channel being horizontally swivellable in sections. It is composed of a fixed section 35 and a swivellable tubular section 36, which are fluidically connected to each other at a hinge 37 and convey a gas flow 34. At an end of swivellable section 36 at the building field side lying opposite hinge 37 is an outlet opening 31. Its extension plane is orthogonal to building field 8 in every position of swivellable section 36.

The position of hinge 37 and the length of swivellable section 36 are matched to one another in such a way that outlet opening 31 at building field edge 81 can be swivelled over its entire length, without passing over building field 8 itself even only partially. Swivellable section 36 thus prevents any action of the laser beam (not represented) on building field 8. To cover opening 41, a blind (not represented) can be fitted to swivellable section 36, which moves with the latter and covers opening 41 optionally at both sides and slides in front of or behind chamber wall 4 on the other side of opening 41.

FIG. 3 shows a comparable diagrammatic cross-sectional view of the device with an alternative partially swivellable gas discharge channel 33; its horizontal swivellable tubular section 36 can be folded into a niche 42 in chamber wall 4. Niche 42 has a depth in the direction of the plane of building field 8 which corresponds at least to the diameter of tubular section 36. Its hinge 37 also lies in niche 42 and connects it to a fixed section (not represented) of gas discharge channel 33. The fixed section can be connected fluidically at the hinge vertically, horizontally or at another angle. At the end lying opposite hinge 37, swivellable section 36 comprises an outlet opening 31 of gas outlet 32.

The swivelling area of swivellable section 36 makes it possible outlet opening 31 to move away from building field edge 81, without projecting over building field 8 itself. Its horizontal swivelling movement does not therefore extend over building field edge 81 into building field 8 or into the volume above building field 8. The volume above building field 8 is thus demarcated from the remaining volume of process chamber 3 or a3, in that a perpendicular is dropped onto building field edge 81. During action of the coater (not represented), e.g. during a coating movement over building field 8, swivellable section 36 folds into niche 42, in order not to impair its working space between building field edge 81 and chamber wall 4 during its operation.

FIG. 4 shows in a further diagrammatic cross-sectional view two partially swivellable gas discharge channels 33a, 33b, which are designed in principle comparable to gas discharge channel 33 of FIG. 3. Their respective hinges 37a, 37b as pivoting points of their swivellable sections 36a, 36b also lie in a niche 42 in chamber wall 4, the dimensions of which correspond to those according to FIG. 3. Its outlet openings 31a, 31b can in each case be swivelled in quarter-circle arcs v between niche 42 and an edge 81 of building field 8 facing them. They reach their smallest distance from building field edge 81 in each case at the left-hand and right-hand ends of building field edge 81. With a deflection on the geometrical centre of quarter-circle arc v or at 45° with respect to the position folded completely into niche 42, both gas discharge channels 33a, 33b can simultaneously act on a central area of building field edge 81, so that they also ensure a suitable gas flow 34 there (see FIG. 1). The two swivellable sections 36a, 36b can also be folded completely into niche 42 and for the same purpose and using the same advantages as explained in FIG. 3.

FIG. 5 shows a further diagrammatic cross-sectional view, in this case with two different embodiments of a movable gas discharge channel on both sides of an axis of symmetry a: Left-hand gas discharge channel 33c is composed in the flow direction of a horizontally rail-guided outlet opening 31c, a connecting flexible section 38c and a swivellable section 36c, which is fluidically connected at a hinge 37c to a fixed section 35.

Right-hand gas supply channel 33d comprises an outlet opening 31d comparable to outlet opening 31c, to which a flexible section 38d for example comprising a corrugated tube is connected, which is coupled mechanically and fluidically directly, i.e. in particular without the interposition of a hinge, to fixed section 35.

Swivellable section 36c and flexible section 38d can be swivelled in an essentially V-shaped niche 43, which adjoins opening 41 on its side facing away from building field 8. Outlet openings 31c, 31d run on a rail 50, which runs transversely through entire opening 41 in chamber wall 4 and parallel to building field edge 81. Outlet openings 31c, 31d can thus be displaced horizontally along the entire length extent of building field edge 81, without thereby passing over it and thus passing into or over building field 8. Since they run rail-guided in the plane of chamber wall 4, they at no time impair the action of the coater (not represented). Together with outlet openings 31c, 31d, a partition wall, a linked curtain or a blind 55 can be moved on raid 50, which covers or closes opening 41 beside outlet openings 31c, 31d in alignment with chamber wall 4. It can keep a movement space of swivellable section 36c or of flexible section 38d inside V-shaped niche 43 free from impurities.

FIG. 6 shows a further diagrammatic cross-sectional view with a rail-guided movable outlet opening 31d and a flexible section 38d in V-shaped niche 43 according to FIG. 5. Diverging therefrom, however, rail 50 lies close to building field edge 81, in order to cooperate with a gas inlet 30 on a shorter path. An arrangement of outlet opening 31d close to the building field does not exclude the arrangement of a partition wall (not represented) for protecting opening 41 in chamber wall 4.

Outlet opening 31d acts on building field 8 in a main direction of action corresponding to axis b. A gas inlet 30 movable over building field 8 forms a flow cone 12 of the inflowing process gas and, for process-related reasons, is directed with its main direction of action corresponding to axis c at an angle to chamber wall 4. The two axes b, c thus enclose an angle α. Gas inlet 30 and gas outlet 32 are consequently not aligned coaxial with one another. As regards the control, an angle threshold value for angle α is stored, which must not be exceeded. Otherwise, the risk could arise that outlet opening 31d no longer completely covers flow cone 12, so that parts of its gas volume are not discharged directly out of process chamber 3, but beforehand can lead for example to undesired turbulence. Flow cone 12 is, in the plan view show here, a partial portion of trapezoidal target flow supply zone 21, which extends from the inlet opening of gas inlet 30 in the direction of outlet opening 31d of gas outlet 32. Target flow supply zone 21 represents a defined minimum area of action of gas inlet 32, from which impurities of the atmosphere of process chamber 3 are effectively removed. A target ventilation zone 22 semicircular in plan view extends around outlet opening 31d of gas outlet 32 and forms a defined minimum area of action of gas outlet 32. Location and optionally orientation and extension of target flow supply zone 21 and of target ventilation zone 22 are coordinated in the control with the position of process point 9 on building field 8, in such a way that the most effective possible removal of impurities from an area of process chamber 3 close to the building field takes place above building field 8. A particularly favourable alignment of gas inlet 30 and gas outlet 32 with one another is shown in the present representation, in that flow cone 12 and therefore a significant proportion of the impurity which has penetrated through inflowing gas from process point 9 is targeted essentially directly into the outlet opening of gas outlet 32. This reduces the probability of an undesired dwell of the impurity longer than necessary in process chamber 3, e.g. in the form of a vertical vortex or a roller.

FIG. 7 shows a further diagrammatic cross-sectional view of a gas outlet 32 with an alternative movable or displaceable outlet opening 31e. V-shaped niche 43, which tapers from opening 41 in chamber wall 4, emerges on its side facing away from the building field into a fixed section 35e of a gas discharge channel 33e. A plurality of also fixed vertical wall sections 39e arranged in a fan-shaped manner lie in front in the flow direction. They give niche 43 the shape of an outlet funnel segmented in the horizontal direction. Each section 39e emerges on the building field side with an outlet opening 31e in the extension plane of chamber wall 4. Each outlet opening 31e can be closed preferably fluid-tight with a slat 54 displaceable in the plane of chamber wall 4 independently of an adjacent or another outlet opening 31e.

FIG. 8 shows a view of chamber wall 4 according to intersecting line VIII-VIII in FIG. 7. The essentially horizontally extending rectangular opening 41, which extends transversely and over the length of building field edge 81, is divided geometrically viewed into six square areas 56. Two of the latter represent outlet openings 31e, the remaining ones are closed by slats 54. By actuating slats 54, square areas 56 can be switched in each case independently of one another from a closed position into outlet openings 31e. Outlet openings 31e at building field edge 81 can thus be changed very flexibly and quickly in their position. A positional change of outlet openings 31e lasts only as long as square area 56 is opened or closed. Opening 41 can also be controlled in patterns other than the manner represented in FIG. 8, for example with only one outlet opening 31e corresponding to a square area 56, with two or more areas 56 lying beside one another as outlet opening 31e up to all opened areas 56 as a single outlet opening 31e. Outlet opening(s) 31e can thus be varied not only with regard to their position, but also with regard to their size.

In a simpler embodiment, opening 41 can comprise precisely four horizontally displaceable slats 54, so that two square areas 56 remain unclosed as outlet openings 31e. Unclosed areas 56 or outlet openings 31e can be arranged at each of the six positions inside opening 41 and also beside one another.

FIG. 9 shows a view of chamber wall 4 with an opening 41. It is composed of two rows 57 lying vertically above one another in chamber wall 4 comprising in each case six square areas 56. Each row 57 is constituted and controlled in principle like opening 41 according to FIG. 8. Displaceable slats 54 form as it were a linked curtain, which has a high temperature resistance on account of the temperatures prevailing in process chamber 3.

In the represented pattern, i.e. with an identical control of upper and lower row 57, the suction intensity at building field edge 81 can be locally intensified. With a respectively individual control of upper and lower row 57, on the other hand, one or more outlet openings 31e can be moved above one another and independently of one another and their position can be adapted to the present requirements for example of the position of a plurality of movable gas inlets or a current concentration or quantity of impurities of the gas atmosphere over the building field 8.

FIG. 10 shows a view of chamber wall 4 according to intersecting line X-X in FIG. 5. In rectangular opening 41, which extends transversely and over the length of building field edge 81, two outlet openings 31c and 31d can be displaced horizontally. They thus cover entire building field edge 81 in terms of flow.

FIG. 11 shows a comparable view to FIG. 10, but with two openings 41 lying vertically one above the other. Outlet openings 31c or 31d can be moved horizontally in each of openings 41. The latter can thus be moved completely independently of one another and achieve a high concentration of their effectiveness in particular in a vertical direction.

Since the preceding manufacturing devices described in detail are examples of embodiment, they can be modified in the usual manner by the person skilled in the art over a wide range, without departing from the scope of the invention. In particular, the specific embodiments of the outlet openings can follow in a shape other than in the one described here. The process chamber and the building field can also be constituted in a different form, if this is necessary for space reasons or on design grounds. Furthermore, the use of the indefinite article “a” does not exclude the fact that the features concerned may also be present several times or repeatedly.

### LIST OF REFERENCE NUMBERS

a1 laser sintering or laser fusion device

a2 object

a3 process chamber

a4 chamber wall

a5 building container

a6 wall

a7 working plane

a8 building field

a10 movable carrier

a11 base plate

a12 building platform

a13 unsolidified building material

a14 storage container

a15 powder-like building material

a16 coater

a18 overflow container

a20 illumination device

a21 laser

a22 laser beam

a23 deflection device

a24 focusing device

a25 coupling window

a29 control unit

a30 gas inlet nozzle

a31 gas outlet nozzle

a32 gas supply channel

a33 gas discharge channel

a34 gas flow

3 process chamber

4 chamber wall

8 building field

9 process point

12 flow cone

21 target flow supply zone

22 target ventilation zone

30 gas inlet

31, 31a . . . 31e outlet opening

32 gas outlet

33, 33a . . . 33e gas discharge channel

35, 35a . . . 35e fixed section

36, 36a . . . 36c swivellable section

37, 37a . . . 37c hinge

38c . . . 38d flexible section

39e fixed section

41 opening

42, 43 niche

50 rail

54 slat

55 blind

56 square area

57 row

81 building field edge

a axis of symmetry

b effective axis of gas outlet 32

c effective axis of gas inlet 30

v quarter-circle arc αangle between axes b, c

1. A manufacturing device for the additive manufacturing of a three-dimensional object, wherein the object is manufactured by applying a building material layer by layer and selective solidification of the building material at points in each layer which are assigned in this layer to the cross-section of the object, whereby the points are scanned with at least one exposure area,
with a building container for receiving the building material,
with a process chamber above the building container,
with a building field between the building container and the process chamber,
with at least one gas inlet for introducing process gas into the process chamber,
with at least one gas outlet for discharging the process gas from the process chamber,
wherein the at least one gas outlet can be moved solely outside the building field.

2. The manufacturing device according to claim 1, wherein the outlet opening of the at least one gas outlet can be moved in at most one degree of freedom in translation and/or in at most one degree of freedom in rotation relative to the building field.

3. The manufacturing device according to claim 1, characterised in that the outlet opening is arranged in a wall of the process chamber and/or adjacent to or close to an edge of the building field.

4. The manufacturing device according to claim 1, characterised in that the outlet opening is arranged essentially horizontally displaceable.

5. The manufacturing device according to claim 1, characterised in that the outlet opening is constituted on a movable nozzle.

6. The manufacturing device according to claim 1, characterised in that the outlet opening is implemented by a slider in the wall.

7. The manufacturing device according to any one of the above claims 1, characterised in that the outlet opening has a variable opening cross-section.

8. The manufacturing device according to claim 1, characterised in that at least two outlet openings are arranged one above the other on the same side of the process chamber and/or that at least two outlet openings are arranged on the adjacent and/or opposite sides of the process chamber.

9. The manufacturing device according to claim 1, characterised in that the travel path or the opening of the gas outlet has at least the length of a building field side, along which it acts.

10. The manufacturing device according to claim 1, characterised by at least one outlet opening per activatable radiation beam bundle of the manufacturing device.

11. The manufacturing device according to claim 1, characterised in that the outlet opening is movable in a lower half of a clear height of the process chamber.

12. A method for producing a three-dimensional object by means of an additive manufacturing device with a gas inlet and a movable gas outlet for the process gas in accordance with claim 1, wherein the object is manufactured by the application of a building material layer upon layer and selective solidification of the building material at points in each layer which are assigned in this layer to the cross-section of the object, in that the points are scanned with at least one exposure area, wherein the movable gas outlet is assigned during operation to a reference process point and/or a target ventilation zone of the movable gas outlet assigned to the reference process point.

13. The method according to claim 12, characterised in that the control of the movement of an outlet opening of the gas outlet takes place dependent on a detected local impurity concentration in the process chamber above the building field.

14. The method according to claim 12, wherein the gas inlet is movable, characterised in that the orientation of an opening of the gas inlet is selected/adjusted dependent on a position or orientation of the outlet opening of the gas outlet.

15. The method according to claim 14, characterised in that an angle, which the opening planes of the gas inlet and of the gas outlet enclose with one another, does not exceed a predefined angle threshold value.
